(19) United States
(12) Patent Application Publication
(10) Pub. No.: US 2012/0316947 A1
(43) Pub. Date: Dec. 13, 2012

(54) Token Management System and Method

(76) Inventor: Christopher Quinlan, Wilmington, DE (US)

(21) Appl. No.: 13/395,008

(22) PCT Filed: Sep. 8, 2010
(86) PCT No.: PCT/US2010/048182

§ 371 Date: Jul. 30, 2012

Related U.S. Application Data
(60) Provisional application No. 61/240,640, filed on Sep. 8, 2009.

(51) Int. Cl. G06Q 30/02; G06Q 30/06

(52) U.S. Cl. 705/14.23; 705/26.1

(57) ABSTRACT

A method for managing tokens is provided that is useful for offering and redeeming rebates on product purchases. A purchaser receives an unactivated token having a unique token identifier. The purchaser undertakes a first purchase transaction using a transaction system. The token identifier is recorded by the transaction system along with the transaction details, including any products for which a rebate is offered. The purchaser receives a receipt for the transaction including a transaction identifier. The purchaser accesses, for example, a home computer, to provide the transaction identifier and the token identifier to a token qualifying system. The token qualifying system analyzes the purchaser information, rebate criteria and transaction information received from the transaction system to qualify a purchase for a rebate. When qualified, the token qualifying system sends an indication to a token accounting system to activate the token by funding a token account. The purchaser may then use the token for a second purchase transaction.

### CROSS REFERENCE TO RELATED APPLICATIONS

This application claims benefit of provisional applications Ser. Nos. 61/240,640 and 61/257,409 naming inventor Christopher Quinlan, filed in the United States Patent & Trademark Office on Sep. 8, 2009 and Nov. 2, 2009 respectively both of which are incorporated herein by reference in their entirety.

### FIELD OF THE INVENTION

The present invention relates generally to methods and systems for managing tokens and more particularly to systems and methods for managing tokens for enabling purchasers to redeem product rebates.

### BACKGROUND OF THE INVENTION

A ‘token’ as used herein refers to an object issued for use as a substitute for currency. One example of a token is a rebate flyer. Other examples include credit cards and gift cards. Virtual tokens include graphic icons and other symbols representing monetary value accruing to a computer user. A rebate is an amount paid by way of reduction, return, refund or supplement to what has already been paid or contributed. For purposes of this specification the term ‘rebate’ refers to a type of sales promotion used as an incentive for a consumer to purchase a product. The term ‘rebate’ also refers to a reduction, return, refund or supplement issued to a consumer, or to a retail seller of consumer products, by a government agency under a government sponsored rebate program, such as the programs to encourage purchase of energy efficient applicances.

The invention provides systems and methods which enable sellers (retailers, manufacturers, etc.) of products to offer product purchase incentives to consumers, thereby providing cost savings to product purchasers, while allowing the seller to avoid the negative economic impact of a temporary price reduction on the product. Further, the invention provides systems and methods which enable sellers of products to offer ‘instant’ incentives to purchasers, while averting the loss to the seller associated with returns of purchased items for which an incentive has already been disbursed. Further, the invention provides new and improved methods and systems for providing purchase incentives, including incentives offered by third parties for purchase of certain types of products, e.g., government or other agency rebates for purchase of energy efficient appliances.

Rebate programs may employ various rebate mechanisms. The mail-in rebate (MIR) is the most common type of rebate. A MIR entitles the buyer to mail in a coupon, a receipt and barcode in order to receive a check for a particular amount, depending on the particular product, time, and often place of purchase.

Rebates benefit consumers by offering lower pricing to all consumers who purchase the product in accordance with the rebate offer criteria. However, not all consumers who otherwise meet the criteria for a rebate on a particular purchased item will redeem that rebate. For instance, for rebate amounts equaling 30% of the price of an item, it is estimated that only 20%-40% of rebate-qualified purchasers of the item will actually redeem the rebate and receive his or her payout. Many consumers are deterred from carrying out the steps necessary to redeem a rebate by lack of time, lack of desire, or other personal reasons.

Instant rebates are more attractive to some consumers. An ‘instant rebate’ is a marketing strategy in which a product is either advertised at a specific price, or at a discounted price, where the discount is applied at the time of purchase. For example, the store may advertise a widget for $9.99, but with a $5 instant rebate, the price is $4.99. Or the product may be advertised as $4.99 with a $5 instant rebate. Instant rebates differ from “standard” rebates in that the instant rebate is provided immediately, at the instant of purchase. Therefore, the purchaser need not expend extra redemption steps associated with the standard rebate.

While instant rebates may be more attractive to some consumers, instant rebates are typically costly for the retailer or manufacturer to implement. When a retailer or manufacturer offers an “Instant” rebate, everyone who purchases the offered item qualifies for, and receives the rebate at the point of purchase. This results in 100% redemption ratio. From the seller's viewpoint, a 100% redemption ratio is essentially the same as a temporary price reduction (TPR) for the item. Many retailers, product manufacturers and other sellers cannot afford to offer such temporary price reductions.

Another problem associated with instant rebates is the loss incurred by a seller when a rebate is issued to a purchaser at the time of purchase, and the purchased item is later returned. When a purchaser returns an item and receives a refund of the purchase price, the seller may not recover the amount of the rebate.

What are needed are systems and methods which would enable sellers (retailers, manufacturers, etc.) of products to offer product purchase incentives to consumers, thereby providing cost savings to product purchasers, while allowing the seller to avoid the negative economic impact of a temporary price reduction on the product. Further needed are systems and methods which enable sellers of products to offer ‘instant’ incentives to purchasers, while averting the loss associated with returns of purchased items for which an incentive has already been disbursed.

Further needed are systems and methods which enable sellers of products which may qualify for ‘green’, and similar rebates, to offer associated rebate amount as ‘instant’ incentives to purchasers, while averting any loss associated with returns of purchased items for which an incentive has already been disbursed.

The present inventors have recognized this problem and have provided systems and methods for providing purchase incentives.

### SUMMARY OF THE INVENTION

The invention provides systems and methods which enable sellers (retailers, manufacturers, etc.) of products to offer product purchase incentives to consumers, thereby providing instant cost savings to product purchasers, while allowing the seller to avoid the negative economic impact of a temporary price reduction on the product. Further, the invention provides systems and methods which enable sellers of products to offer ‘instant’ incentives to purchasers, while averting the loss to the seller associated with returns of purchased items for which an incentive has already been disbursed.

### DESCRIPTION OF THE DRAWING FIGURES

These and other objects, features and advantages of the invention will be apparent from a consideration of the following detailed description of the invention considered in conjunction with the drawing figures, in which:

FIG. 1 is a block diagram of a token qualifying system according to an embodiment of the invention;

FIG. 2 is a block diagram illustrating a token qualifying system implemented to provide purchase incentives according to one embodiment of the invention;

FIG. 3 is a block diagram illustrating a token qualifying system implemented to provide purchase incentives including incentives from a third party system according to one embodiment of the invention;

FIG. 4 illustrates a first example graphical user interface for a system such as the system depicted in FIG. 3 according to an embodiment of the invention;

FIG. 5 illustrates a second example graphical user interface for a system such as the system depicted in FIG. 3 according to an embodiment of the invention;

FIG. 6 illustrates a third example graphical user interface for a system such as the system depicted in FIG. 3 according to an embodiment of the invention;

FIG. 7 is a block diagram of a token qualifying system according to an embodiment of the invention;

FIG. 8 is a flowchart depicting a method for managing tokens according to an embodiment of the invention;

FIG. 9 is a flowchart illustrating a method for managing tokens as carried out by a transaction system according to an embodiment of the invention;

FIG. 10 is a flowchart illustrating a method for managing tokens as carried out by a service provider according to an embodiment of the invention.

### DETAILED DESCRIPTION OF THE INVENTION

In accordance with the present invention, there are provided herein methods and systems for managing tokens. For purposes of this specification the term ‘token’ refers to an object issued for use as a substitute for currency. Examples of tokens include conventional token objects such as pieces of stamped metal. Further examples according to the invention include portable, wallet size memory devices such as flash memory devices as well as plastic cards, including, but not limited to credit cards, gift cards, rebate cards and the like. The term ‘token’ as used herein may refer to virtual objects as well as tangible objects. For example, a virtual token comprises a graphic icon or other symbol. Tokens comprise plastic gift cards according to some embodiments of the invention.

However, the invention is not limited to plastic cards. Any type of object is suitable for use in tangible or virtual form as a token in the various embodiments of the invention, as long as the object is issuable to a token beneficiary and capable of bearing a token identifier. The token identifier is used to associate a particular token with a corresponding assigned token value. Accordingly, a plurality of identical appearing tokens may be issued wherein each of the issued tokens may be assigned a different monetary or currency value.

In one example embodiment of the invention, a retail sales clerk dispenses a token upon token holder 305 visiting the retail outlet, for example, to make a purchase. Alternatively, a token is mailed by retail sales system 200 to token holder 305 as part of an advertising campaign.

A variety of means for dispensing tokens to token holders are suitable for use in the invention. In some embodiments of the invention, token 215 is automatically dispensed from a token dispensing device, for example, upon completion of an electronic purchase transaction. In that case, transaction system 200 may comprise an electronic vending device. The vending device 200 automatically associates an identification number for a dispensed token with information about items purchased in an electronic transaction. In that case the value of the token will be determined by token qualifying system 400 in accordance with the terms of any product rebate offers associated with items included in the token holder's electronic purchase transaction.

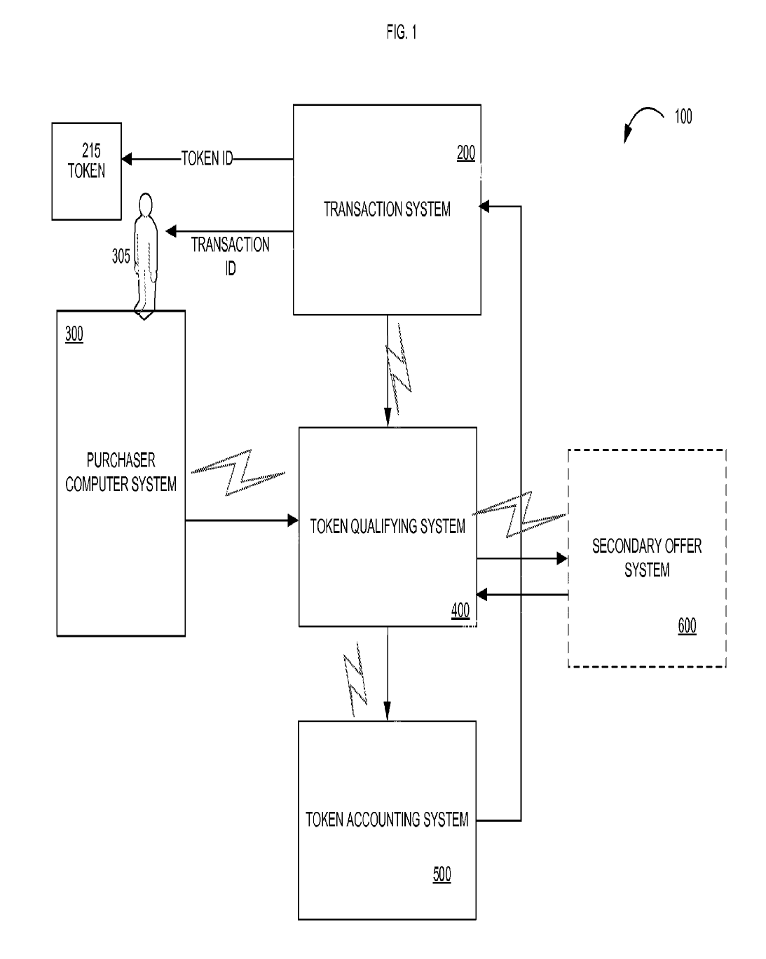

### FIG. 1 Token Management System Block Diagram

A method for managing tokens is provided that is useful for offering and redeeming rebates on product purchases. An overview of system operation is as follows. A purchaser receives an un-activated token having a unique token identifier. The purchaser undertakes a first purchase transaction using a transaction system. The token identifier is recorded by the transaction system along with the transaction details, including any products for which a rebate is offered. The purchaser receives a receipt for the transaction including a transaction identifier. The purchaser accesses, for example, a home computer, to provide the transaction identifier and the token identifier to a token qualifying system. The token qualifying system analyzes the purchaser information, rebate criteria and transaction information received from the transaction system to qualify a purchase for a rebate. When qualified, the token qualifying system sends an indication to a token accounting system to activate the token by funding a token account. The purchaser may then use the token for a second purchase transaction.

FIG. 1 is a block diagram of a token management system 100 according to one embodiment of the invention. System 100 comprises a token qualification system 400 configured to communicate via a communications link with a purchaser system 300, and a transaction system 200 to implement various embodiments of the invention. Some embodiments of the invention further comprise a token accounting system communicating with the token qualifying system and a secondary offer system 600 configured to communicate with token qualifying system 400.

### Token 215

A token 215 is a device such as a plastic card that enables its holder 305 to interact with various electronic transaction systems 200 to capture and redeem benefits accruing to the token holder from the token holder's transactions.

### Transaction System 200

Transaction system 200 comprises an electronic transaction information capture system. For example, in a retail setting, transaction system 200 comprises a point of sale system. In that case, system 200 captures information related to purchase transactions such as items purchased, item price, time of transaction, etc. Suitable devices for capturing information related to purchase transactions include electronic cash registers, scanners, computers and a variety of other electronic devices.

Advantageously, token 215 enables transaction system 200 to capture detailed information about transactions as they are undertaken. In one embodiment of the invention, the detailed transaction information is associated with the token holder's token. For example, while making a purchase, a purchaser presents his token to a cashier who swipes the token through an electronic card reading device. The cashier also enters, or electronically captures information about each item purchased. Therefore, the token identifier is captured by transaction system along with the details of the transaction. A transaction identifier is assigned to the transaction. At the conclusion of a transaction system 200 provides the purchaser with a receipt. The receipt includes the transaction identification number.

The purchaser may then submit the transaction identification number and the token identification number to token qualifying system 400 and request that system 400 determine benefits associated with the token holder's transactions. System 400 determines benefits and effects delivery of benefits to the purchaser by causing token 215 to be activated. In this example, the term ‘activated’ refers to the process of funding an account linked to the token identifier. The purchaser is able to use the activated token to make future purchases, in a manner similar to a credit card, debit card or gift card. The benefits associated with token 215 may be applied by the token holder to future transactions involving a transaction system 200.

### Token Accounting System 500

Token accounting system 500 converts token value to a monetary payment and provides the payment to the transaction system 200 when a token is redeemed. In one embodiment of the invention token accounts system 500 comprises a financial system such as a bank. In one embodiment of the invention transaction system 200 generates tokens configured for electronic transactions in accordance with the invention. Tokens comprising plastic cards are configured in a manner similar to credit cards. That is, each card is imprinted with a unique token identification number. Token accounts system 500 relies on the unique identification number when crediting a token for benefits and debiting a token for expenditures.

### Token Qualifying System 400

Token qualifying system 400 carries out a token evaluation process in response to a request by a purchaser who has received an un-activated token. An un-activated token is one for which no funds are available in a funding account. To qualify a token, system 400 evaluates products comprising a purchase transaction. Products for which a rebate, or other reward, is offered are identified by comparing the products in the transaction to a database storing product and associated offer information. System 400 determines if the terms of the offer are met by analyzing factors such as date of purchase, lapsed time between purchase and redemption, expiration date of the offer and other criteria specified by the offeror of the rebate.

When system 400 determines a product in the transaction is qualified for a rebate, system 400 sends an indication to token accounting system 500 that the token associated with the transaction including that product is to be activated. Any value accruing to the purchaser is associated with the purchaser's token The value of any benefit, e.g., a rebate value, may be applied in a second transaction, e.g., as an offset against the purchase price of the second transaction.

Regardless of how token holder 305 receives token 215, token holder 305 presents token 215 to the retail clerk during a purchase transaction. Token identification information is transferred from the token to a memory of transaction system 200, for example by the clerk swiping the token through an electronic card reading device. The token identification information is associated with information about items purchased during the transaction. If a purchased item is determined to be associated with a rebate, and the terms of the rebate offer are determined to be met, the value of the rebate is associated with the token. To receive the benefit of the offer, token holder 305 presents the token during a subsequent purchase transaction with retail system 200. The token identification information is again transferred to retail system 200. Any value previously associated with the token's identification code is automatically accounted for in the transaction.

### Secondary Offer System 600

Some embodiments of the invention include a secondary offer system 600. Secondary offer system 600 comprises, e.g., a third party offeror of rebates or rewards. For example, an energy company, government agency or other third party may offer rebates for purchase of energy efficient appliances.

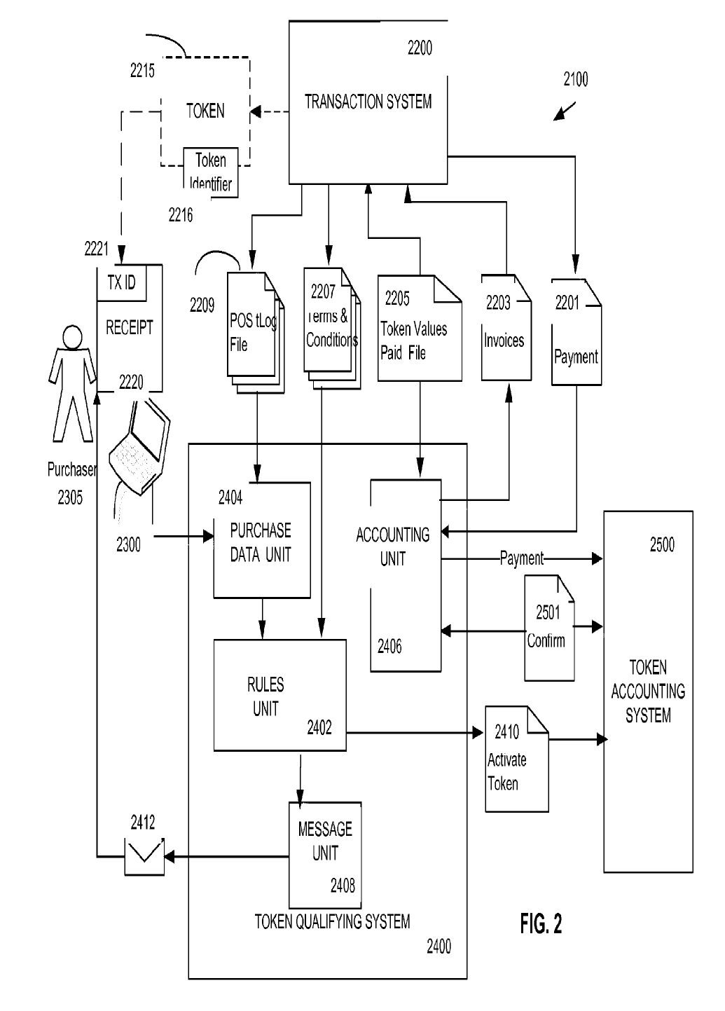

### FIG. 2

FIG. 2 is a block diagram illustrating a token management system implemented to provide purchase incentives according to one embodiment of the invention. Purchaser 2305 purchases at least one item via a transaction system 2200 of a retail establishment.

In one embodiment of the invention purchaser 301 purchases a product from a seller, for example, from a retailer wherein the retailer processes purchase transactions via a retailer system 2200. The invention is deployed for purchased products for which the seller offers purchase incentive. To implement the purchase incentive, the seller provides the customer with a gift card (token) 2215 at the time of the customer's purchase. In one embodiment of the invention, token 215 is branded, or otherwise associated with the seller, for example, with retailer 2200. In one embodiment of the invention token 2215 includes a unique token identifier 2216. A token identifier 2216 is an identification number, code, or serial number unique to an individual gift card. The unique identification code may be electronically embedded, or visibly marked on token card 2215.

In one embodiment of the invention, the token can be associated with an “active” status or with an ‘inactive’ status according to a token issuer, for example, token accounting system 2500. For ease of discussion of the embodiment illustrated in FIG. 2, it is assumed token 2215 has an inactive status at the time the customer receives token 2215 from retailer 2200.

Transaction system 2200 electronically records token information, for example, at least the token identifier 2216 at the point of sale (POS). For example, a retail sales clerk passes a token through an electronic card reading device comprising retail system 2200 before handing the token to purchaser 2305. The electronic card reading device obtains the token number from the token as the token is passed through the device. Transaction system 2200 includes, e.g, a POS tLog file comprising information for all swiped tokens 2215. The information comprises at least the unique token number associated with each token 2215.

To receive the value of the offer represented by token 2215, purchaser 2305 provides the unique token identification code for his card to token qualifying system 2400. For example, purchaser 2305 may submit the token identification code via a purchaser system 2300 such as a personal computer configured to communicate with token qualifying system 2400 via the internet. However, the invention is not limited to submission of the token identification code by a purchaser's computer system. Alternatively, the code may be submitted by a purchaser via a postal service, telephone, text message, or any other communication means.

A purchase data unit 2404 of token qualifying system 2400 receives the purchase transaction log information 2209 from transaction system 2200, including the recorded token identifiers. Qualifying system 2400 compares this log information to the transaction information received from purchaser system 2300. In that manner rebate system 2400 prepares to validate the token information provided by purchaser 301 via purchaser system 300.

A rules unit 2402 receives rules, terms, conditions and other criteria for redeeming a token as specified by transaction system 2200, or a third party rebate offeror. Once purchase data unit 2404 identifies purchased items associated with a rebate, rules unit 2402 analyzes the details of the transaction and, in some embodiments, other information such as purchaser information, to determine if the criteria for the rebate are met. For example, some rebates may have expiration dates. In that case, rules unit 2402 compares todays date with the expiration date to determine if the time limit for redemption is exceeded. If so, the token is not qualified. If the token is qualified, system 2400 sends an indication, e.g., an electronic message, to token accounting system 2500 that the token is to be activated.

An accounting unit 2406 of token qualifier system 2400 periodically, e.g., weekly, determines the value of validated token offers. Accounting unit 2406 system provides an invoice 2203 to transaction system 2200 based on the validated token information. In one embodiment, the invoice accounts for the rebate value of all validated tokens for an invoice period.

Accounting unit 2406 receives invoice payments 2201 from transaction system 2200. In response to receiving payment for an invoiced token value, rebate system 2400 provides an associated token activation file to token accounting system, e.g., a card issuer system 2500. In response to receiving a token activation file from qualifying system 2400, card issuer system 2500 confirms token activation by providing a confirmation indication to rebate system 2400.

In response to receiving a confirmation indication from token issuer system such as token accounting system 2500, rebate system 2400 provides a message to purchaser 2301 via, e.g., purchaser system 2300. In one embodiment of the invention system 2400 sends an email to purchaser 2301 via purchaser system 2300 indicating approval of the purchaser's request (made when the purchaser submitted his token information) to receive the incentive associated with the purchaser's token. In one embodiment of the invention, rebate system 2400 further indicates activation of the purchaser's token to purchaser system 2300. In one embodiment of the invention, the value of the purchase incentive is credited to the token of purchaser 2301.

Once rebate system 2400 has provided purchaser 2301 with the value of the purchaser's token, rebate system 2400 provides a “token paid” file to retailer system 2200. In one possible scenario, purchaser 2301 subsequently returns the purchased item for which the purchaser received an associated token value. In that case, retailer system 2200 compares information associated with the returned item to the information in the token paid files received from rebate system 2400 to determine if purchaser 2301 has received the token value for the item. If the token value has been received for a returned item, retailer system 2200 enables the seller to account for the value of the token when providing a refund to purchaser 2301. In that manner system 2100 mitigates loss to a seller when purchaser 2301 returns a purchased item for which an incentive has already been disbursed to purchaser 2301.

In one embodiment of the invention, token qualifying system 2400 generates a request for tokens to be generated. For example, in one embodiment of the invention token 2215 comprises a gift card. Token dispensing system 2200 comprises a retail outlet system, and token generating system 2500 comprises a financial institution system that generates cards and provides the cards to retail outlets. The gift card is dispensed to a consumer as incentive to purchase certain products.

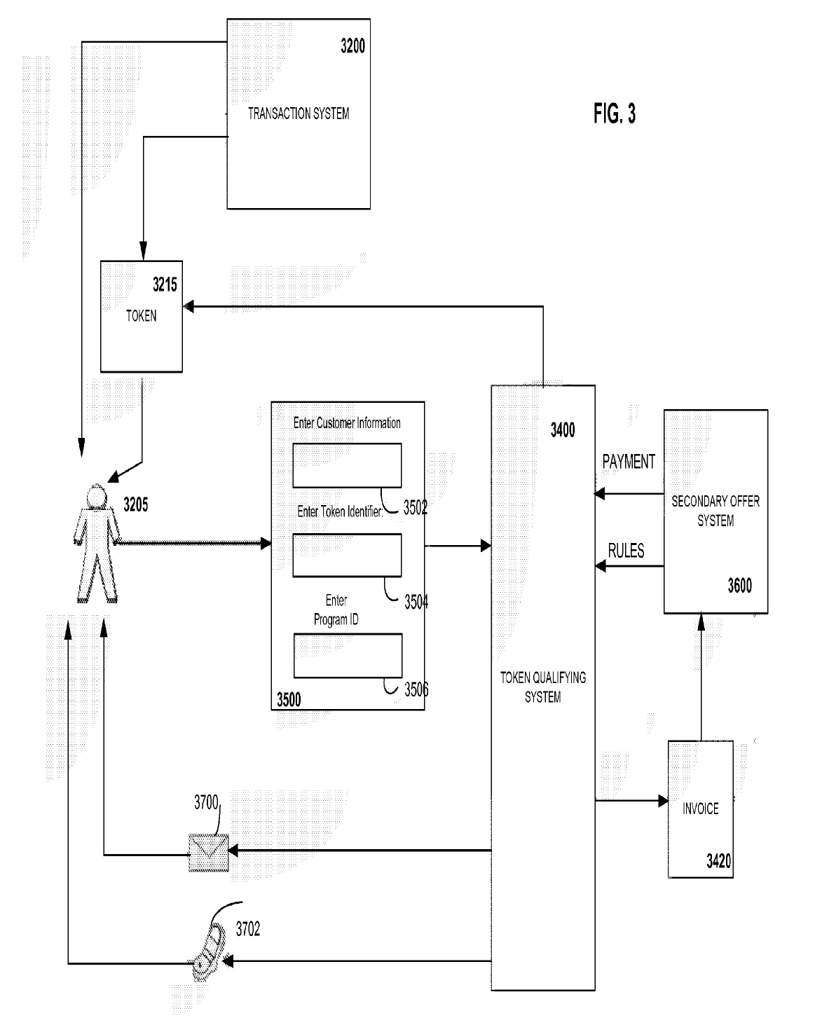

### FIG. 3

FIG. 3 is a pictorial diagram illustrating a graphical user interface GUI suitable for implementing the invention on a display of a purchaser system. In one example embodiment, GUI 400 enables a purchaser to input the purchaser's information at 402 and his token identifier at 404.

system and method for providing instant purchase incentives according to one embodiment of the invention.

### Transaction System

In one embodiment of the invention a purchaser 3301 purchases a product from a seller, for example, from a retailer wherein the retailer processes purchase transactions via a retailer system 3200. The purchased product is one for which the seller offers an purchase incentive.

### Gift Card

To implement the purchase incentive, the seller provides the customer with a gift card (TOKEN) 3215 at the time of the customer's purchase. In one embodiment of the invention, token 3215 is branded, or otherwise associated with the seller, for example, with retailer 3200. In one embodiment of the invention token 3215 includes a unique gift card number 3216. A gift card number is an identification number, code, or serial number unique to an individual gift card. The unique identification code may be electronically embedded, or visibly marked on token card 3215. In one embodiment of the invention, the token can be associated with an “active” status or with an ‘inactive’ status. In the embodiment illustrated in FIG. 1 token 3215 has an inactive status at the time the customer receives token 3215 from retailer 3200.

### POS

Retailer system 3200 electronically records token information, for example, at least the gift card number at the point of sale (POS). For example, a retail sales clerk passes a token through an electronic card reading device comprising retail system 3200 before handing the token to purchaser 3301. The electronic card reading device obtains the token number from the token as the token is passed through the device. Retailer system 3200 includes a POS tLog file comprising information for all swiped tokens 3215. The information comprises at least the unique token number associated with each token 3215.

### Redemption

To receive the value of the offer represented by token 3215, purchaser 3301 provides the unique token identification code for his card to rebate system 3400. For example, customer 300 may submit the identification code via a purchaser system 3300 configured to communicate with rebate system 3400 via the internet. However, the invention is not limited to submission of the identification code by a purchaser's computer system. Alternatively, the code may be submitted by a purchaser via a postal service, telephone, text message, or other communication means.

### Rebate System

Rebate system 3400 receives the purchase transaction log information from retail system 3200, including the recorded token numbers. Rebate system 3400 compares this log information to the purchase incentive information received from purchaser system 300. In that manner rebate system 3400 validates the token information provided by purchaser 3301 via purchaser system 3300. Rebate system 3400 periodically, e.g., weekly, determines the value of validated token offers. Rebate system 3400 provides an invoice to retail system 200 based on the validated token information. The invoice accounts for the rebate value of all validated tokens for an invoice period.

Rebate system 3400 receives invoice payments from retailer system 3200. In response to receiving payment for an invoiced token value, rebate system 3400 provides an associated token activation file to card issuer system 3500. In response to receiving a token activation file from rebate system 3400, card issuer system 3500 confirms token activation by providing a confirmation indication to rebate system 3400.

In response to receiving a confirmation indication from card issuer system 3500, rebate system 3400 provides a message to purchaser 3301 via, e.g., purchaser system 3300. In one embodiment of the invention system 3400 sends an email to purchaser 3301 via purchaser system 3300 indicating approval of the purchaser's request (made when the purchaser submitted his token information) to receive the incentive associated with the purchaser's token. In one embodiment of the invention, rebate system 400 further indicates activation of the purchaser's token to purchaser system 3300. In one embodiment of the invention, the value of the purchase incentive is credited to the token of purchaser 3301.

### Returns

Once rebate system 3400 has provided purchaser 3301 with the value of the purchaser's token, rebate system 3400 provides a “token paid” file to retailer system 3200. In one possible scenario, purchaser 3301 subsequently returns the purchased item for which the purchaser received an associated token value. In that case, retailer system 3200 compares information associated with the returned item to the information in the token paid files received from rebate system 3400 to determine if purchaser 3301 has received the token value for the item. If the token value has been received for a returned item, retailer system 3200 enables the seller to account for the value of the token when providing a refund to purchaser 3301. In that manner system 3100 mitigates loss to a seller when purchaser 3301 returns a purchased item for which an incentive has already been disbursed to purchaser 3301.

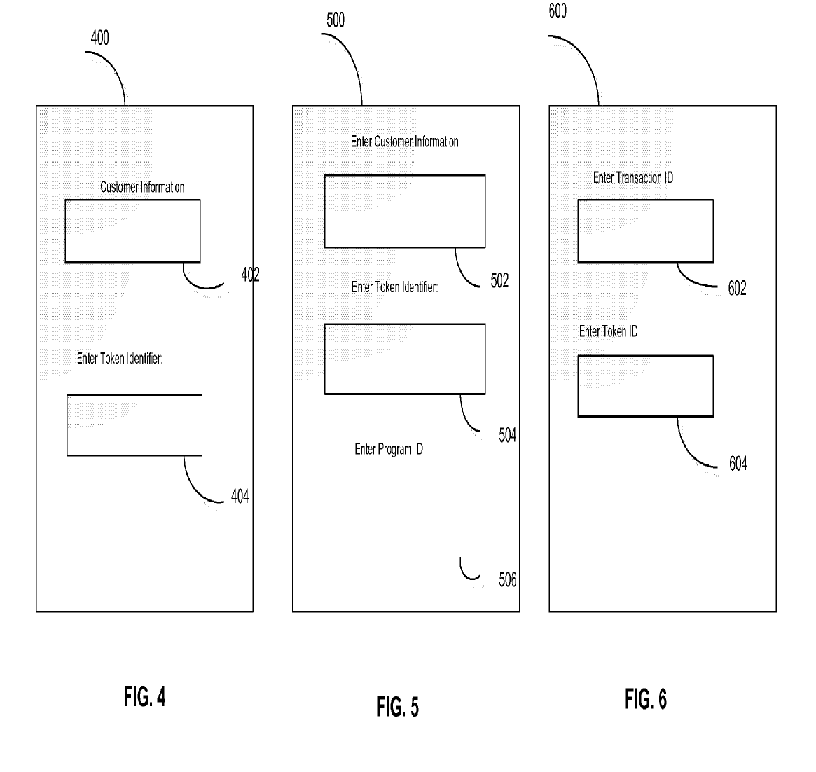

### FIG. 4

FIG. 4 is a pictorial diagram illustrating a system and method for providing instant purchase incentives according to one embodiment of the invention. FIG. 5 illustrates a GUI enabling a purchaser to provide purchaser information at 502, a token identifier at 504 and an indication of a third party rebate program at 506. In embodiments of the invention involving third party offerors, the indication at 506 is used by system 2400 to direct data to the third party system as described below.

In one embodiment of the invention a purchaser 301 purchases a product from a seller, for example, from a retailer 305 wherein the retailer processes purchase transactions via a retailer processing system. For example, a retailer/seller of, among other things, appliances may qualify a purchaser for an energy related rebate as an ENERGY STAR appliance. Retailer may process such appliance purchase transactions via a Retailer's purchase transaction processing system. In the example above, the purchased appliance may be one for which a state or local government entity, the seller, or other third party offeror, offers an incentive for the purchase. In one example embodiment, an incentive comprises an entitlement for the purchaser 301 to free delivery on a qualifying purchase from seller 305. For example, a purchase exceeding a predetermined value, e.g., $399.00, may be a qualifying purchase.

### Token 315

To implement a purchase incentive associated with purchase of a qualifying product, the seller 305 provides purchaser 301 with a gift card (token) 315 at the time of the customer's purchase. In one embodiment of the invention, token 315 is branded, or otherwise associated with the seller, for example, a retailer provides a Sears “gift card 307 at a point of sale (POS) of an appliance which qualifies for an ENERGY STAR rebate. In one embodiment of the invention token 307 is activated and ready for use by customer 301 at the time customer 301 accepts the card from seller 305. Token 307 includes a transaction identifier related to his purchase. Token 307 further includes an indicator that a rebate-qualified purchase has been made.

In one embodiment of the invention, customer 301 employs a customer's personal computer to connect to a rebate processing system 311, e.g., via the Internet. System 311 provides an interactive graphical user interface to the customer's computer 309. Customer 301 uses the interactive interface to register card 307 for receiving credit related to a specified type of rebate offer, e.g., ENERGY STAR related rebates. To register token 307, the customer enters coded information from the card to be provided to rebate processing system 311.

Rebate processing system 311 validates the information provided by customer 301 and communicates with a rebate provider, e.g., ENERGY STAR utilities 313 to notify the rebate provider that customer 301 has made a rebate qualifying purchase, and that customer 301 has authorized the rebate amount to be applied as a credit to token 307. In response to the notification from rebate processor 311, rebate provider 313 enables rebate processor 311 to credit token 307 with a value related to the rebate amount.

Rebate processing system 311 validates the information provided by customer 301. Upon validation and response from rebate provider 313, rebate processing system 311 generates an email notifying customer 301 that his card 307 has been validated. In one embodiment of the invention, customer 301 is notified that a rebate credit has been applied, and the card 307 is ready for use by customer 301. In one embodiment of the invention, rebate processing system 311 provides rebate provider system 313 with an invoice, e.g., an electronic invoice reflecting the amount of the applied rebate.

In one embodiment of the invention token 307 includes a unique gift card number. A gift card number may be an identification number, code, or serial number unique to an individual gift card. The unique identification code may be electronically embedded, or visibly marked on token card 307. In one embodiment of the invention, the token 307 can be associated with an “active” status or with an ‘inactive’ status. In the embodiment illustrated in FIG. 3 token 307 has an active status at the time the customer receives token 307 from retailer 305.

### POS

In one embodiment of the invention, Retailer system 305 electronically records token 307 information, for example, at least the gift card number at the point of sale (POS). For example, a retail sales clerk passes a token 307 through an electronic card reading device comprising retail system 305 before handing the token 307 to purchaser 301. The electronic card reading device obtains the token number from the token as the token is passed through the device. According to one embodiment of the invention, Retailer system 305 includes a POS tLog file comprising information for all swiped tokens 307. The information comprises at least the unique token number associated with each token 307.

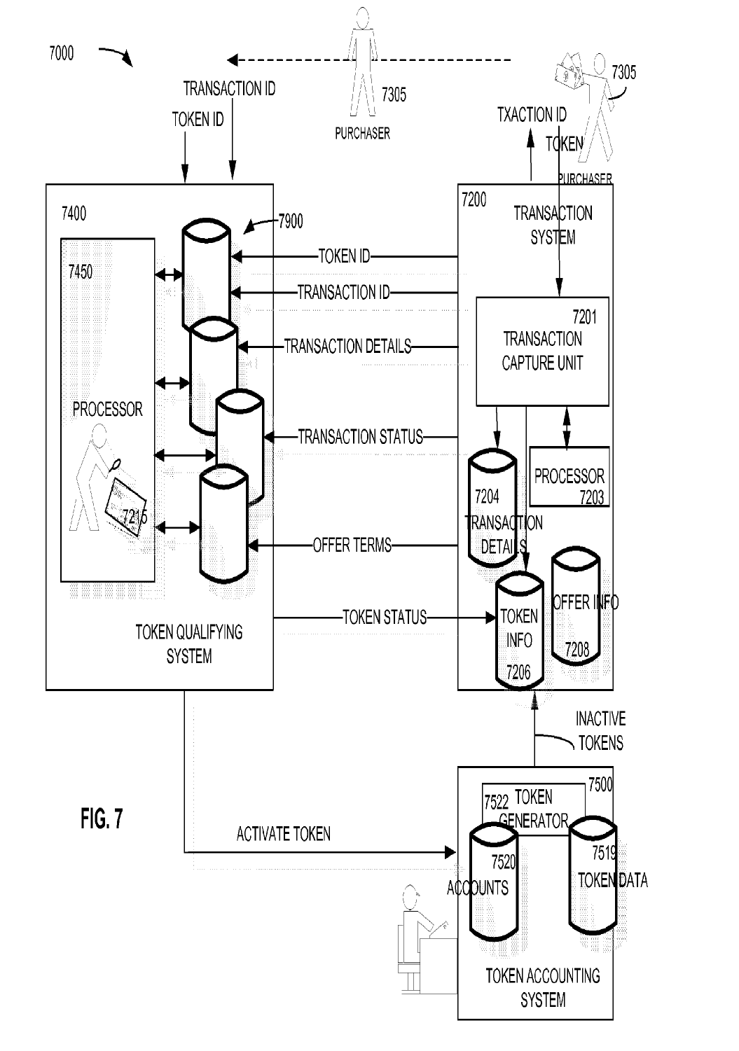

### FIG. 7

FIG. 7 is a block diagram of a token qualifying system according to an embodiment of the invention.

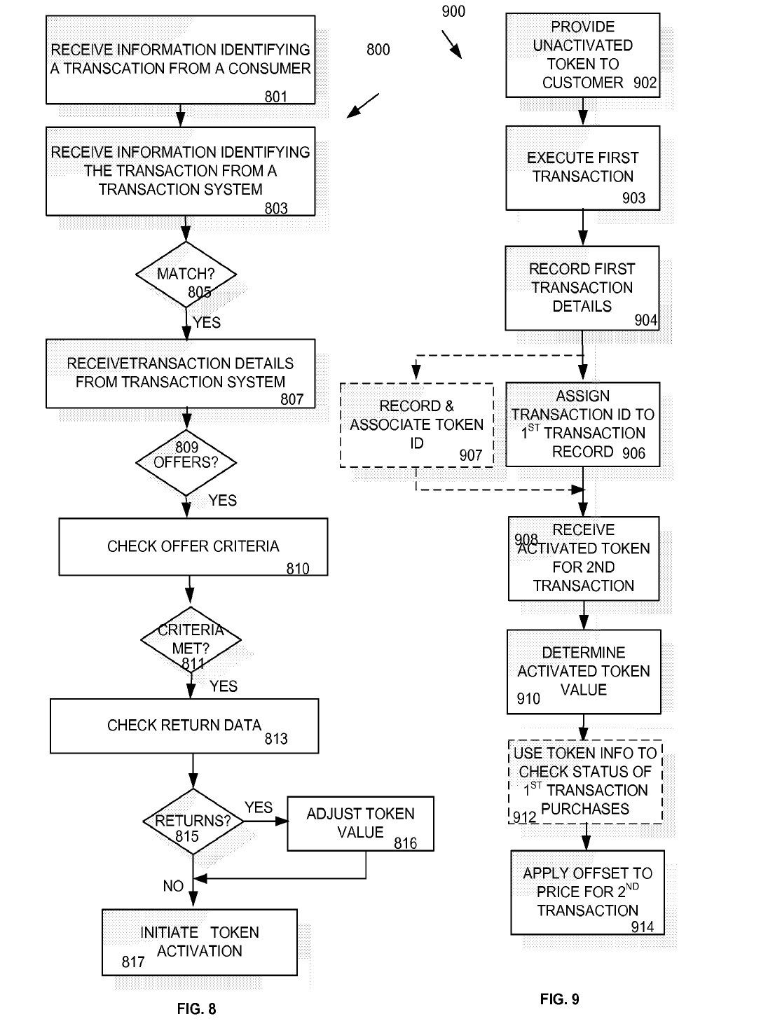

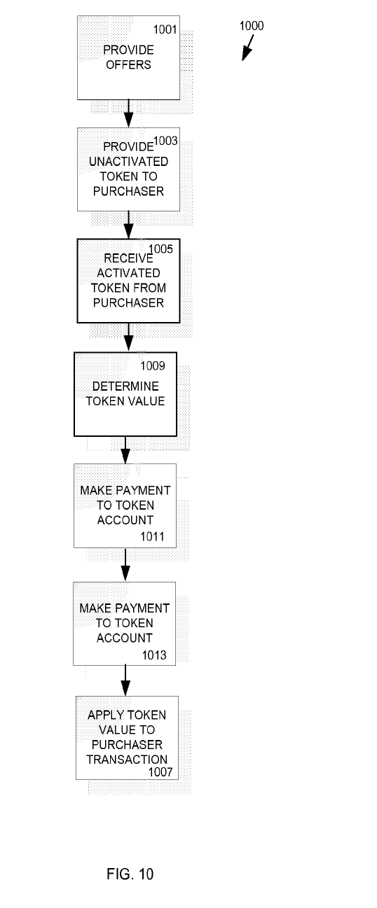

### FIG. 8

FIG. 8 is a flowchart depicting a method for qualifying tokens according to an embodiment of the invention carried out by token qualifying system 400. A method for managing tokens comprises receiving token identifying information from a purchaser at 801 and receiving information identifying the transaction at 803. The token is used to access information related to a first transaction of the purchaser at 805 by matching the information. System 400 receives transaction details including items purchased from transaction system 200 at 807. System 400 determines if any purchased items are subject to rebate offers at 809. System 400 analyzes token activation criteria and analyzes the information related to the first transaction of the purchaser and the token activation criteria to determine if the token activation criteria are met at 811. If the token activation criteria are met, system 400 checks a return data file to determine if any items associated with the rebate and the transaction have been returned at 813. If items have been returned, an amount related to the value of the returned item is deducted from the value assigned to a token. System 400 sends a token activation signal to a token activation system at 817.

### FIG. 9

FIG. 9 is a flowchart illustrating a method for executing transactions involving tokens. A token is provided to a purchaser at 902. At 904 the purchaser executes a first transaction and the first transaction details are recorded. At 906 a first transaction identifier is recorded. After qualifying for a rebate the purchaser visits the retail outliet to undertake a second transaction using his activated token at 908. Transaction system 200 determines the value of the activated token by referencing the token identification number. At least a portion of the value of the token is applied to the purchase transaction at 912.

There have thus been provided new and improved methods and systems for providing purchase incentives, including incentives offered by third parties for purchase of certain types of products, e.g., government or other agency rebates for purchase of energy efficient appliances.

While the invention has been shown and described with respect to particular embodiments, it is not thus limited. Numerous modifications, changes and enhancements will now be apparent to the reader.

We claim:

1. A method of performing electronic transactions comprising:
providing to a purchaser a token in an un-activated state, the token bearing a token identifier;
executing a first transaction for the purchaser including recording a transaction identifier and information related to purchases comprising the first transaction;
receiving the token in an activated state from the purchaser and executing a second transaction for the purchaser;
applying an offset to the purchase price of the second transaction the amount of the offset based on a value of the token in an activated state.

2. The method of claim 1 further comprising recording the electronic token identifier in association with the transaction identifier.

3. The method of claim 2 further comprising using the electronic token identifier to access and analyze the information related to purchases comprising the first transaction to determine status of the purchases.

4. The method of claim 3 including adjusting the offset to the purchase price of the second transaction based on the status of the purchases comprising the first transaction.

5. The method of claim 1 further comprising providing the token identifier to a token qualification system.

6. The method of claim 1 further comprising a step of providing the transaction identifier to a token qualification system.

7. The method of claim 1 further comprising receiving an indication of the value of the token in an activated state from a token qualification system, carried out before the step of applying an offset.

8. The method of claim 1 including:
to be carried out after applying the offset, receiving from the purchaser at least one item of the items comprising the first transaction, the at least one item to comprise a return transaction;
receiving the transaction identifier from the first transaction,
determining an amount of the offset applied to the purchase price in the second transaction;
adjusting the value of the return transaction based on the amount of the offset.

9. A method for managing tokens comprising:
receiving token identifying information from a purchaser;
using the token identifying to access information related to a first transaction of the purchaser;
receiving token activation criteria:
analyzing the information related to the first transaction of the purchaser and the token activation criteria to determine if the token activation criteria are met;
if the token activation criteria are met, sending a token activation signal to a token activation system.

10. The method of claim 9 wherein the token identifying information comprises a transaction identification code wherein the transaction identification code is stored in a memory in association with a token identifier.

11. The method of claim 9 wherein the token identifying information comprises a token identifier.

12. The method of claim 9 including:
receiving token identifying information for a plurality of tokens from a transaction system;
for each of the plurality of tokens receiving associated information for corresponding transactions of the plurality of purchasers;
selecting information related to a transaction of the purchaser by comparing the token identification information received from the purchaser to the token identifying information received from the transaction system.
